(19) United States
(12) Patent Application Publication
(10) Pub. No.: US 2026/0290740 A1
(43) Pub. Date: Sep. 24, 2026

(54) MULTI-POINT GAS-DISCHARGE X-RAY TUBE FOR STATIONARY COMPUTED TOMOGRAPHY SYSTEMS

(71) Applicant: Creighton Scientific, LLC, Highland, UT (US)

(72) Inventor: Richard Thomas Creighton, Aptos, CA (US)

(73) Assignee: Creighton Scientific, LLC, Highland, UT (US)

(21) Appl. No.: 19/572,682

(22) Filed: Mar. 19, 2026

Related U.S. Application Data
(60) Provisional application No. 63/774,695, filed on Mar. 19, 2025.

(51) Int. Cl. H01J 35/18; G01N 23/046; H01J 9/395; H01J 35/20

(52) U.S. Cl. CPC H01J 35/18; G01N 23/046; H01J 9/395; H01J 35/20

(57) ABSTRACT

An X-ray source comprising a gas enclosure configured to retain a mixture of gasses at a pressure below atmospheric pressure, a plurality of spark gap assemblies mounted to the gas enclosure, each spark gap assembly of the plurality of spark gap assemblies comprising an electrical feedthrough configured to generate X-rays via gas discharge across a spark gap, and a plurality of X-ray window assemblies mounted to the gas enclosure, each X-ray window assembly of the plurality of X-ray window assemblies positioned adjacent a corresponding spark gap assembly of the plurality of spark gap assemblies such that X-rays generated by the corresponding spark gap assembly pass through the X-ray window assembly.

### CROSS-REFERENCE TO RELATED APPLICATION

This application claims priority to U.S. Provisional Application No. 63/774,695, filed Mar. 19, 2025, which application is incorporated by reference herein.

### BACKGROUND

X-ray computed tomography (CT) is commonly used in industrial inspection, scientific, and medical applications. A variety of methods are employed to capture multiple images of the sample or subject to acquire enough information to reconstruct a three-dimensional image. Some systems rotate a sample between an X-ray source and X-ray detector, while other systems rotate an X-ray source and detector around a sample.

### BRIEF DESCRIPTION OF THE DRAWINGS

FIG. 1 illustrates a multi-point gas-discharge X-ray source.

FIG. 2 illustrates a single point X-ray source where a spark gap is integrated as a part of an assembly that is inserted into a multi-point tube and is attached permanently.

FIG. 3 illustrates a single point X-ray source where a spark gap is integrated as a part of the assembly that is inserted into a multi-point tube and is screw mountable.

FIG. 4 illustrates a single point X-ray source where a spark gap is between the end of a feedthrough and an X-ray window. The window and feedthrough are not removeable.

FIG. 5 illustrates a single point X-ray source from FIG. 1 where a spark gap is between an end of a feedthrough and an X-ray window. The window and feedthrough are screw mountable.

FIG. 6 illustrates a single point X-ray source where a gas-discharge in a spark gap can be initiated with a triggering grid.

FIG. 7 is a flow diagram illustrating operations of a method for manufacturing a multi-point gas-discharge X-ray source.

FIG. 8 illustrates a single point X-ray source with an X-ray detector positioned to receive X-rays generated by the spark gap assembly.

### DETAILED DESCRIPTION

Conventional CT methods involving rotating the detector or the sample have been employed successfully in many applications, but there are some cases where the sample or subject is unable to be rotated and the cost, size, and/or weight of rotating the X-ray source and detector is impractical. Thus, conventional X-ray CT systems are ill-suited for use in applications such as emergency vehicles, remote locations, or large sized samples.

Stationary CT machines have been developed to address applications where rotation is impossible or impractical. In a stationary X-ray CT machine, many X-ray sources are triggered in sequence around the sample or subject and images are collected by multiple detectors positioned around the sample or subject. An X-ray source in a stationary X-ray CT system needs to be able to turn on and off quickly so that a full acquisition of images can be collected for reconstruction. Cold cathode field emission X-ray sources have been developed and commercialized for stationary X-ray CT systems. Cold cathode X-ray sources typically employ carbon nanotubes or photocathodes as field emitters. A simple grid next to the cathode can be pulsed to extract electrons from the emitter which are accelerated by a high voltage field until interacting with a target to produce X-rays.

While cold cathode emitters are effective at being used for stationary X-ray CT systems, the cost of producing a large number of individual X-ray tubes for the system is higher than traditional X-ray CT systems and is not practical in some applications. In addition to the higher upfront costs, field emitters such as carbon nanotubes typically have poor reliability due to the sensitivity of the nanotube structures to ion bombardment. This causes increased service costs and system downtime.

The present disclosure provides an innovative X-ray source for stationary computed tomography (CT) X-ray systems. The innovation allows for customized and varied X-ray source designs to be manufactured in a way that is cost effective. This enables stationary X-ray CT manufacturers to design new systems that can meet needs that were previously impossible or impractical. Examples and embodiments described herein provide for an X-ray source that is maintained at a small partial pressure of various gasses ranging between a total pressure of 10⁻³ torr and 400 torr. Thus, the X-ray source does not require the same high vacuum processing required by conventional CT systems, such as systems using cold cathode and filamentary tubes. Examples and embodiments discussed herein provide for generation of X-rays using gas-discharge over a spark gap. X-rays that are produced by gas-discharge over a spark gap exhibit a phenomenon known as the pinch effect, which yields X-ray photons of much higher kilovolt peak than the sparking voltage. This eliminates or minimizes the amount of high voltage processing that is required for typical vacuum X-ray tubes so that they can reliably tolerate the voltages stresses presented during the lifetime of the tube.

Embodiments and examples discussed herein solve the technical problem of large, complex CT systems that cannot be implemented in mobile or remote applications. Embodiments and examples discussed herein provide for an X-ray source including modular, lightweight spark gap assemblies for generating X-rays. In some implementations, the spark gap assemblies for the X-ray source can all be powered by a single power source, greatly decreasing the weight and complexity of a CT assembly incorporating the X-ray source. By sequentially activating the spark gap assemblies, X-ray data for a sample can be captured from multiple different directions, providing a comprehensive view of the sample using the low-cost, lightweight X-ray source.

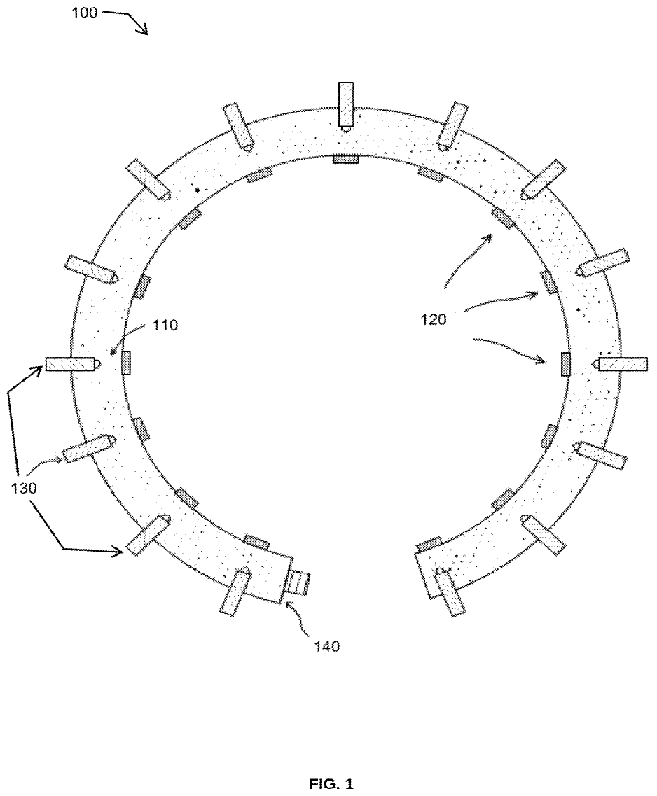

FIG. 1 illustrates a multi-point gas-discharge X-ray source 100. The source includes a gas enclosure 110, a plurality of X-ray window assemblies 120, a plurality of spark gap assemblies 130, and a seal 140. The gas enclosure 110 can be a tube or other hollow structure configured to retain gasses (e.g., at pressures less than atmospheric pressure). The gas enclosure 110 (e.g., tube) can contain gasses such as Hydrogen, Nitrogen, Methane, Argon, and/or Xenon. The plurality of X-ray window assemblies 120 can be positioned along the gas enclosure 110 (e.g., at regular intervals). The plurality of X-ray window assemblies 120 can include X-ray windows including rolled beryllium, chemical vapor deposition (CVD) diamond, a supported polymer film, and/or a graphene film to allow efficient transmission of generated X-rays. The plurality of spark gap assemblies 130 can each include an electrical feedthrough and fittings allowing the gas enclosure 110 to be filled with the correct gas ratio and pressure and then sealed with the seal 140. The end of the electrical feedthrough of each of the plurality of spark gap assemblies 130 forms a spark gap. The plurality of spark gap assemblies 130 are placed adjacent the plurality of X-ray window assemblies 120 so that X-rays generated from the gas discharge of the plurality of spark gap assemblies 130 are able to pass through the plurality of X-ray window assemblies 120. In an example, each spark gap assembly of the spark gap assemblies 130 is located adjacent a corresponding X-ray window of the plurality of X-ray windows 120 such that X-rays generated by the spark gap assembly pass through the corresponding X-ray window, as illustrated in FIG. 1. The plurality of spark gap assemblies 130 and the plurality of X-ray window assemblies 120 can include any number of spark gap assemblies and X-ray window assemblies, respectively. In some implementations, the X-ray source includes spark gap assemblies and corresponding X-ray window assemblies positioned at regular intervals, where a number of the spark gap assemblies and corresponding X-ray window assemblies corresponds to a length of the gas enclosure 110.

In some implementations, the plurality of X-ray window assemblies 120 and the plurality of spark gap assemblies 130 align with one or more X-ray detectors. In some implementations, the one or more X-ray detectors are positioned within a plane of the X-ray source 100. In an example, the one or more X-ray detectors are positioned within a plane of a circle formed by the X-ray source 100 and the plurality of spark gap assemblies 130 and the plurality of X-ray window assemblies 120 are mounted in line with the plane formed by X-ray source 100 such that X-rays generated by the plurality of spark gap assemblies 130 pass through the plurality of X-ray window assemblies 120 and the sample to reach the one or more X-ray detectors within the plane of the X-ray source 100. In some implementations, the one or more X-ray detectors are positioned outside of the plane for the X-ray source 100. The plurality of spark gap assemblies 130 and the plurality of X-ray window assemblies 120 can be mounted offset from the plane of the X-ray source 100 such that the X-rays generated by the plurality of spark gap assemblies 130 pass through the plurality of X-ray window assemblies 120 and the sample to reach the one or more X-ray detectors outside of the plane of the X-ray source.

While the X-ray source 100 is illustrated as forming a circle, or a nearly-complete circle, the X-ray source 100 can form any portion of an arc of a circle or ellipse. In an example, the X-ray source 100 forms an arc for use in tomosynthesis.

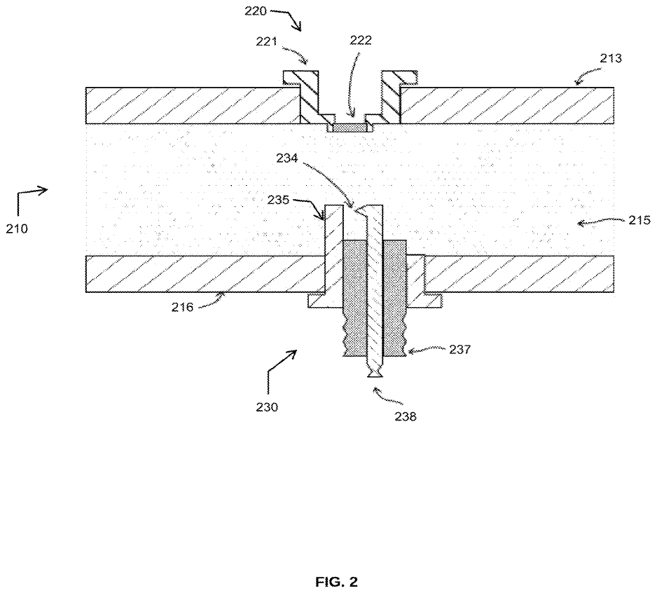

FIG. 2 illustrates an example spark gap assembly 230 and an example window assembly 220 affixed to a gas enclosure 210, such as the gas enclosure 110 of FIG. 1. The window assembly 220 may be an example of a window assembly of the plurality of X-ray window assemblies 120 of FIG. 1. The spark gap assembly 230 may be an example of a spark gap assembly of the plurality of spark gap assemblies 130 of FIG. 1. The window assembly 220 includes a frame 221 and an X-ray transmissive window material 222. The window assembly 220 is connected to an inner surface 213 of the gas enclosure 210. The spark gap assembly 230 includes an electrical feedthrough 238, enshrouded by an electrical insulator 237, and a housing 235.

The spark gap assembly 230 is formed by bonding the electrical feedthrough 238 to the electrical insulator 237. The electrical insulator 237 comprises a ceramic component that has been machined to include a central bore or channel configured to receive the electrical feedthrough 238. The electrical feedthrough 238 comprises a metal electrode that is inserted into the machined opening of the electrical insulator 237 and bonded to the inner wall of the ceramic component using techniques such as brazing, glass-to-metal sealing, or active metal brazing to create a hermetic seal between the metal and ceramic materials. This bonding process ensures that the spark gap assembly 230 maintains gas-tight integrity while providing electrical isolation between the high-voltage electrode and the grounded housing 235. The ceramic material of the electrical insulator 237 may comprise alumina, aluminum nitride, or other electrically insulating ceramics selected for their ability to withstand high voltage stresses and maintain structural integrity under thermal cycling conditions. A tip of the metal electrode extends beyond the ceramic insulator 237 to form one terminal of the spark gap at the interface 234.

X-rays are generated at an interface 234 between the tip of the feedthrough 238 and the housing 235 (the nearest electrical connection at ground potential). When a high voltage is applied to the electrical feedthrough 238, the electric field across the spark gap causes ionization of the gas mixture within the gas enclosure 210, initiating a gas discharge. During the gas discharge, electrons are accelerated across the spark gap and interact with the gas molecules and the electrode surfaces, producing X-ray radiation. The X-rays produced by the gas discharge exhibit a phenomenon known as the pinch effect, which yields X-ray photons of higher energy than would be expected from the applied sparking voltage alone. The spark gap assembly 230 is mounted to an outer surface 216 of the gas enclosure 210. The gas enclosure 210 is filled with a mixture of gasses 215 and held at a pressure below atmospheric pressure.

The housing 235 includes a raised portion that extends toward the tip of the electrical feedthrough 238 to define the spark gap. The raised portion is raised relative to an opposite side of the housing 235 and establishes a controlled distance between the raised portion of the housing 235 and the interface 234 where the gas discharge occurs to generate X-rays.

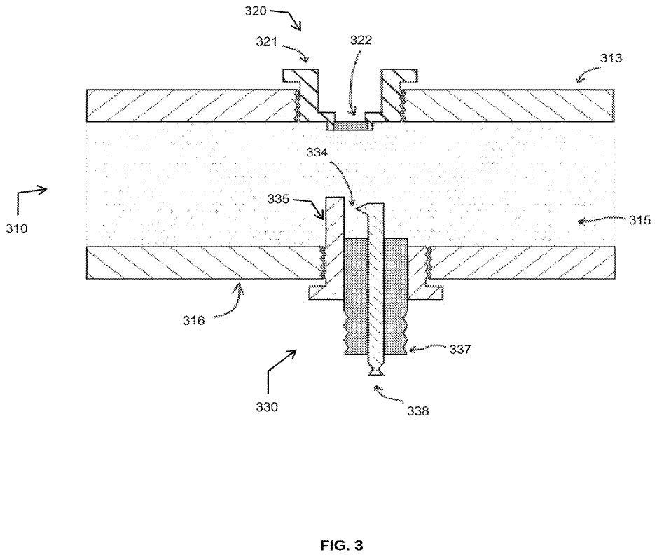

FIG. 3 illustrates an example spark gap assembly 330 and example window assembly 320 where each assembly is screwed into a gas enclosure 310, such as the gas enclosure 110 of FIG. 1. The window assembly 320 may be an example of a window assembly of the plurality of X-ray window assemblies 120 of FIG. 1. The spark gap assembly 330 may be an example of a spark gap assembly of the plurality of spark gap assemblies 130 of FIG. 1. The window assembly 320 includes an outer diameter frame 321 and an X-ray transmissive window material 322. The window assembly 320 can be screwed into an inner diameter 313 of the gas enclosure 310. The spark gap assembly 330 includes an electrical feedthrough 338, enshrouded by an electrical insulator 337, and bonded to a housing 335.

The spark gap assembly 330 is formed by bonding the electrical feedthrough 338 to the electrical insulator 337. The electrical insulator 337 comprises a ceramic component that has been machined to include a central bore or channel configured to receive the electrical feedthrough 338. The electrical feedthrough 338 comprises a metal electrode that is inserted into the machined opening of the electrical insulator 337 and bonded to the inner wall of the ceramic component using techniques such as brazing, glass-to-metal sealing, or active metal brazing to create a hermetic seal between the metal and ceramic materials. This bonding process ensures that the spark gap assembly 330 maintains gas-tight integrity while providing electrical isolation between the high-voltage electrode and the grounded housing 335. The ceramic material of the electrical insulator 337 may comprise alumina, aluminum nitride, or other electrically insulating ceramics selected for their ability to withstand high voltage stresses and maintain structural integrity under thermal cycling conditions. A tip of the metal electrode extends beyond the ceramic insulator 337 to form one terminal of the spark gap at the interface 334.

X-rays are generated at an interface 334 between the tip of the feedthrough 338 and the housing 335 (the nearest electrical connection at ground potential). When a high voltage is applied to the electrical feedthrough 338, the electric field across the spark gap causes ionization of the gas mixture within the gas enclosure 310, initiating a gas discharge. During the gas discharge, electrons are accelerated across the spark gap and interact with the gas molecules and the electrode surfaces, producing X-ray radiation. The X-rays produced by the gas discharge exhibit a phenomenon known as the pinch effect, which yields X-ray photons of higher energy than would be expected from the applied sparking voltage alone. The spark gap assembly 330 can be screw mounted to an outer surface 316 of the gas enclosure 310. The gas enclosure 310 is filled with a mixture of gasses 315 and held at a pressure below atmospheric pressure.

The housing 335 includes a raised portion that extends toward the tip of the electrical feedthrough 338 to define the spark gap. The raised portion is raised relative to an opposite side of the housing 335 and establishes a controlled distance between the raised portion of the housing 335 and the interface 334 where the gas discharge occurs to generate X-rays.

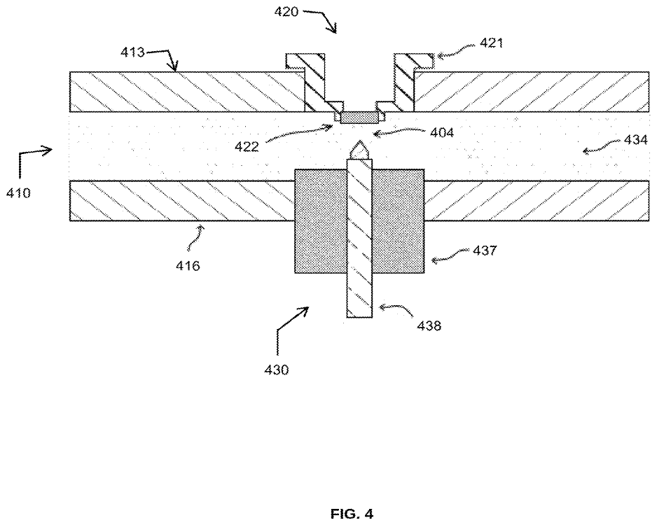

FIG. 4 illustrates an example spark gap assembly 430 and an example window assembly 420 where each assembly is affixed to a gas enclosure 410, such as the gas enclosure 110 of FIG. 1. The window assembly 420 may be an example of a window assembly of the plurality of X-ray window assemblies 120 of FIG. 1. The spark gap assembly 430 may be an example of a spark gap assembly of the plurality of spark gap assemblies 130 of FIG. 1. The window assembly 420 includes a frame 421 and an X-ray transmissive window material 422. The window assembly 420 is connected to an inner diameter 413 of the gas enclosure 410. The spark gap assembly 430 includes an electrical conductor 438 (e.g., electrical feedthrough) enshrouded by an insulator 437 and is affixed to an outer diameter 416 of the gas enclosure 410.

The spark gap assembly 430 is formed by bonding the electrical conductor 438 to the insulator 437. The insulator 437 comprises a ceramic component that has been machined to include a central bore or channel configured to receive the electrical conductor 438. The electrical conductor 438 comprises a metal electrode that is inserted into the machined opening of the insulator 437 and bonded to the inner wall of the ceramic component using techniques such as brazing, glass-to-metal sealing, or active metal brazing to create a hermetic seal between the metal and ceramic materials. This bonding process ensures that the spark gap assembly 430 maintains gas-tight integrity while providing electrical isolation between the high-voltage electrode and the gas enclosure 410. The ceramic material of the insulator 437 may comprise alumina, aluminum nitride, or other electrically insulating ceramics selected for their ability to withstand high voltage stresses and maintain structural integrity under thermal cycling conditions.

A tip of the metal electrode extends beyond the ceramic insulator 437 to form one terminal of the spark gap 404. A gap between the tip of the electrical conductor 438 and the window material 422 forms the spark gap 404 (i.e., interface where X-rays are formed). When a high voltage is applied to the electrical conductor 438, the electric field across the spark gap 404 causes ionization of the gas mixture within the gas enclosure 410, initiating a gas discharge. During the gas discharge, electrons are accelerated across the spark gap 404 and interact with the gas molecules and the X-ray transmissive window material 422, producing X-ray radiation that passes through the window material 422. The gas enclosure 410 (e.g., tube) is filled with a mixture of gasses 434 and held at a pressure below atmospheric pressure.

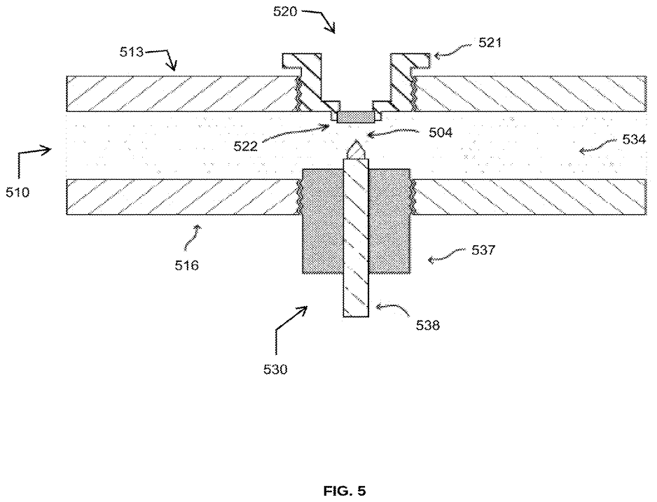

FIG. 5 illustrates an example spark gap assembly 530 and an example window assembly 520 where each assembly is screwed into a gas enclosure 510, such as the gas enclosure 110 of FIG. 1. The window assembly 520 may be an example of a window assembly of the plurality of X-ray window assemblies 120 of FIG. 1. The spark gap assembly 530 may be an example of a spark gap assembly of the plurality of spark gap assemblies 130 of FIG. 1. The window assembly 520 includes a frame 521 and an X-ray transmissive window material 522. The window assembly 520 is screwed into an inner diameter 513 of the gas enclosure 510. The spark gap assembly 530 includes an electrical conductor 538 enshrouded by an insulator 537 and is screwed into an outer surface 516 of the gas enclosure 510.

The spark gap assembly 530 is formed by bonding the electrical conductor 538 to the insulator 537. The insulator 537 comprises a ceramic component that has been machined to include a central bore or channel configured to receive the electrical conductor 538. The electrical conductor 538 comprises a metal electrode that is inserted into the machined opening of the insulator 537 and bonded to the inner wall of the ceramic component using techniques such as brazing, glass-to-metal sealing, or active metal brazing to create a hermetic seal between the metal and ceramic materials. This bonding process ensures that the spark gap assembly 530 maintains gas-tight integrity while providing electrical isolation between the high-voltage electrode and the gas enclosure 510. The ceramic material of the insulator 537 may comprise alumina, aluminum nitride, or other electrically insulating ceramics selected for their ability to withstand high voltage stresses and maintain structural integrity under thermal cycling conditions.

A tip of the metal electrode extends beyond the ceramic insulator 537 to form one terminal of the spark gap 504. A gap between the tip of the electrical conductor 538 and the window material 522 forms the spark gap 504 (i.e., interface where X-rays are formed). When a high voltage is applied to the electrical conductor 538, the electric field across the spark gap 504 causes ionization of the gas mixture within the gas enclosure 510, initiating a gas discharge. During the gas discharge, electrons are accelerated across the spark gap 504 and interact with the gas molecules and the X-ray transmissive window material 522, producing X-ray radiation that passes through the window material 522. The gas enclosure 510 (e.g., tube) is filled with a mixture of gasses 534 and held at a pressure below atmospheric pressure.

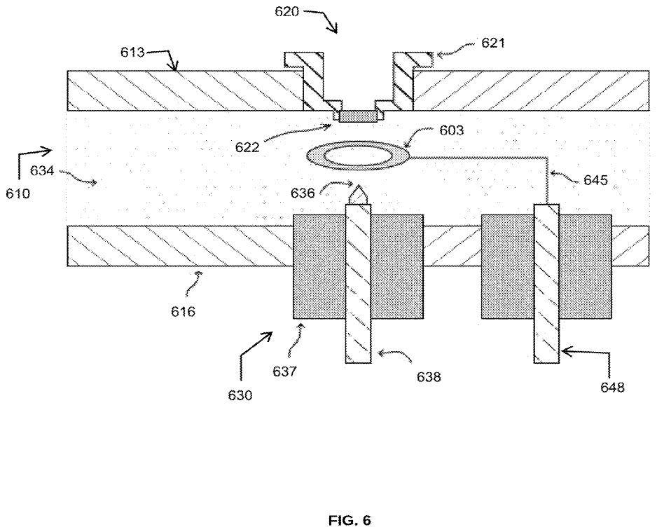

FIG. 6 illustrates an example spark gap assembly 630 and an example window assembly 620 where each assembly is affixed to a gas enclosure 610, such as the gas enclosure 110 of FIG. 1. The window assembly 620 may be an example of a window assembly of the plurality of X-ray window assemblies 120 of FIG. 1. The spark gap assembly 630 may be an example of a spark gap assembly of the plurality of spark gap assemblies 130 of FIG. 1. The window assembly 620 includes a frame 621 and an X-ray transmissive window material 622. The window assembly 620 is connected to an inner diameter 613 of the gas enclosure 610. The spark gap assembly 630 (e.g., feedthrough assembly) includes an electrical conductor 638 enshrouded by an insulator 637 and is affixed to an outer surface 616 of the gas enclosure 610. The electrical conductor 638 is bonded into a ceramic component that has been machined to include an opening configured to receive the electrical conductor 638. The ceramic component serves as the insulator 637 and is machined with a central bore or channel through which the electrical conductor 638 extends. The electrical conductor 638 is inserted into the machined opening and bonded to the inner wall of the ceramic component using techniques such as brazing, glass-to-metal sealing, or active metal brazing to create a hermetic seal between the metal and ceramic materials. This bonding process ensures that the electrical conductor 638 maintains gas-tight integrity while providing electrical isolation between the high-voltage electrode and the gas enclosure 610. The insulator 637 may comprise alumina, aluminum nitride, or other electrically insulating ceramics selected for their ability to withstand high voltage stresses and maintain structural integrity under thermal cycling conditions.

A tip 636 of the metal electrode extends beyond the ceramic insulator 637 to form one terminal of the spark gap. A gap between the tip 636 of the electrical conductor 638 and the window material 622 forms a spark gap (i.e., interface where X-rays are formed). A triggering grid 603 (e.g., ring, filament, etc.) is placed between the tip 636 of the electrical conductor 638 and the window material 622. A second electrical conductor 648 (e.g., second electrical feedthrough) allows a voltage to pass through a wire 645. The wire 645 connects the second electrical conductor 648 to the triggering grid 603, enabling electrical control of the triggering grid 603. When a voltage pulse is applied to the triggering grid 603 through the second electrical conductor 648, the electric field in the region between the tip 636 and the window material 622 is modified, initiating ionization of the gas mixture within the gas enclosure 610. This controlled ionization triggers the gas discharge across the spark gap, causing electrons to accelerate and interact with the gas molecules and the X-ray transmissive window material 622 to produce X-ray radiation that passes through the window material 622.

The second electrical conductor 648 is bonded into a ceramic component that has been machined to include an opening configured to receive the second electrical conductor 648. The ceramic component serves as an insulator and is machined with a central bore or channel through which the second electrical conductor 648 extends, with the bonding process creating a hermetic seal to maintain gas-tight integrity of the gas enclosure 610. A voltage of the second electrical conductor 648 can be changed to control initiation of a gas discharge at the spark gap to produce X-rays. The gas enclosure 610 (e.g., tube) is filled with a mixture of gasses 634 and held at a pressure below atmospheric pressure.

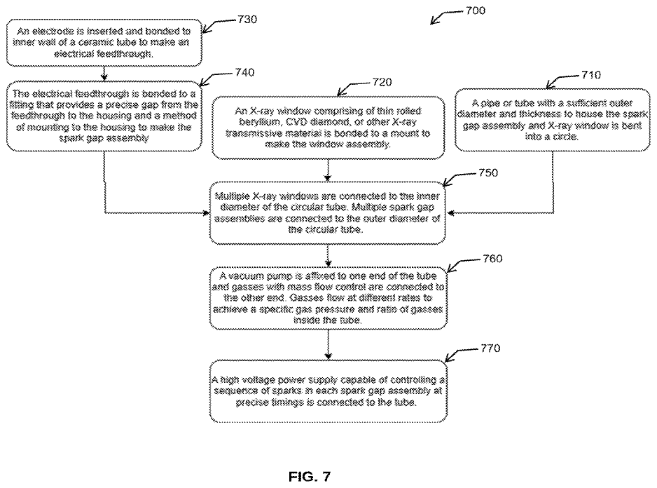

FIG. 7 is a flow chart illustrating operations of an example method 700 for manufacturing a multi-point gas-discharge X-ray tube, such as the X-ray source 100 of FIG. 1. The method 700 may include more, fewer, or different operations than shown. One or more operations can be performed in the order shown, in a different order, or concurrently.

At operation 710, a gas enclosure is formed by bending a tube into a circular shape. A metal tube with sufficient thickness to handle the difference between atmospheric pressure and the total pressure of gasses inside of the chamber is selected. For example, the tube may be configured to withstand pressures between 10⁻³ torr and 400 torr. The total length of the tube is selected based on the number of spark gap assemblies and X-ray window assemblies that are needed. The tube is then bent into a circle or nearly-complete circle to a desired diameter. In some implementations, the tube is bent into an arc rather than a complete or nearly-complete circle. For example, the tube may form an arc of a circle or ellipse for use in tomosynthesis applications where a full circular configuration is not required.

Holes are drilled and tapped at periodic positions around the tube prior to connecting the plurality of X-ray window assemblies and the plurality of spark gap assemblies. For example, the holes may be drilled at regular intervals corresponding to the spacing between adjacent spark gap assemblies and X-ray window assemblies. The drilling operation creates apertures through the tube wall at locations where the X-ray window assemblies and spark gap assemblies will be mounted. In some implementations, a first set of holes is drilled through the inner diameter of the tube for receiving the plurality of X-ray window assemblies, and a second set of holes is drilled through the outer diameter of the tube for receiving the plurality of spark gap assemblies. The holes for the X-ray window assemblies and the corresponding holes for the spark gap assemblies are aligned such that each spark gap assembly is positioned adjacent its corresponding X-ray window assembly to enable X-rays generated at the spark gap to pass through the X-ray transmissive window material.

In some implementations, the holes are tapped with threads to enable screw mounting of the X-ray window assemblies and spark gap assemblies. The threading may be configured to create a gas-tight seal when the assemblies are installed, or additional sealing mechanisms such as O-rings, gaskets, or sealants may be employed to ensure hermetic integrity of the gas enclosure. The precise positioning of the holes around the tube determines the angular spacing between adjacent X-ray sources, which affects the resolution and coverage of the computed tomography system. For example, a tube configured for a stationary CT system may include holes positioned at angular intervals of 5 degrees, 10 degrees, 15 degrees, or other intervals selected based on the imaging requirements of the application. The number of holes drilled corresponds to the number of spark gap assemblies and X-ray window assemblies to be installed, which may range from a minimum of two to as many as the tube geometry and assembly dimensions permit.

At operation 720, each X-ray window assembly of the plurality of X-ray window assemblies is formed. An X-ray transmissive window material is bonded to a frame to form the X-ray window assembly. For example, the X-ray transmissive window material may include thin-rolled beryllium, chemical vapor deposition (CVD) diamond, a supported polymer film, or a graphene film.

In some implementations, each X-ray window assembly is formed by bonding an X-ray transmissive window material to a frame. The frame may be threaded for insertion into the gas enclosure.

In some implementations, bonding the X-ray transmissive window material to the frame comprises at least one of brazing, soldering, or applying an adhesive. For example, the X-ray transmissive window material may be brazed to a metal frame to form a hermetic seal.

At operation 730, an electrical feedthrough is formed for each spark gap assembly. An electrode is inserted into a ceramic tube and bonded to an inner wall of the ceramic tube to form the electrical feedthrough. The ceramic tube serves as an electrical insulator that prevents electrical contact between the electrode and the gas enclosure while maintaining a hermetic seal. The electrode may comprise a conductive metal such as tungsten, copper, or a copper alloy selected for its electrical conductivity and resistance to erosion during spark discharge. The bonding between the electrode and the ceramic tube may be accomplished through brazing, glass-to-metal sealing, or other hermetic bonding techniques that ensure gas-tight integrity at the interface. The ceramic material may comprise alumina, aluminum nitride, or other electrically insulating ceramics capable of withstanding the voltage stresses and thermal cycling associated with spark gap operation. A tip of the electrode extends beyond the ceramic tube to form one terminal of the spark gap, where the gas discharge occurs to generate X-rays.

At operation 740, the electrical feedthrough is bonded to a fitting to form the spark gap assembly. The fitting provides a precise gap from the electrical feedthrough to the fitting, which defines the spark gap where X-rays are generated.

The bonding process between the electrical feedthrough and the fitting may be accomplished through brazing, soldering, welding, or other hermetic joining techniques that ensure both mechanical stability and gas-tight integrity. The fitting is configured to establish a controlled distance between the tip of the electrode extending from the electrical feedthrough and a grounded surface, which may be the fitting itself, the housing, or an adjacent conductive component. This controlled distance determines the breakdown voltage required to initiate the gas discharge and influences the characteristics of the X-rays produced, including their energy spectrum and intensity.

In some implementations, the fitting comprises a raised portion or protrusion that extends toward the tip of the electrical feedthrough to define the spark gap with high precision. The raised portion may be machined to tight tolerances to ensure consistent spark gap distances across all spark gap assemblies in the multi-point X-ray source, thereby providing uniform X-ray output from each point source. The material of the fitting may comprise a conductive metal such as stainless steel, copper, or brass that can withstand repeated spark discharges without excessive erosion or degradation.

In some implementations, the fitting includes threading on an outer surface to enable screw mounting of the spark gap assembly to the gas enclosure. The threaded interface may incorporate sealing features such as O-ring grooves, tapered threads, or surfaces configured to receive sealants to maintain the hermetic integrity of the gas enclosure when the spark gap assembly is installed.

At operation 750, the gas enclosure includes multiple X-ray window assemblies connected to an inner surface of the gas enclosure and the plurality of spark gap assemblies connected to an outer surface of the gas enclosure. Each spark gap assembly is positioned adjacent a corresponding X-ray window assembly.

In some implementations, the plurality of X-ray window assemblies are located in an inner surface of the gas enclosure. For example, the threaded frames of the X-ray window assemblies may be screwed into tapped holes in the inner diameter of the tube. In some implementations, the plurality of spark gap assemblies are located in the outer surface of the gas enclosure. For example, the threaded fittings of the spark gap assemblies may be screwed into tapped holes in the outer diameter of the tube.

At operation 760, the gas enclosure is filled with a mixture of gasses at a pressure below atmospheric pressure. A vacuum pump is affixed to a first end of the tube and gas inputs with mass flow control are connected to a second end of the tube.

In some implementations, gasses are flowed through the gas inputs at different flow rates to achieve a target gas pressure and ratio of gasses within the tube. For example, Hydrogen, Nitrogen, Methane, Argon, and/or Xenon may be introduced at controlled flow rates to achieve a desired gas mixture. In some implementations, the gas enclosure is sealed after achieving the target gas pressure and ratio. For example, the tube may be sealed at both ends once the gas mixture reaches a total pressure between 10⁻³ torr and 400 torr.

At operation 770, a high voltage power supply is connected to the plurality of spark gap assemblies. In some implementations the high voltage power supply is configured to control a sequence of sparks in each spark gap assembly of the plurality of spark gap assemblies. For example, the power supply may sequentially activate individual spark gap assemblies with precise timing to enable computed tomography image acquisition from multiple directions around a sample.

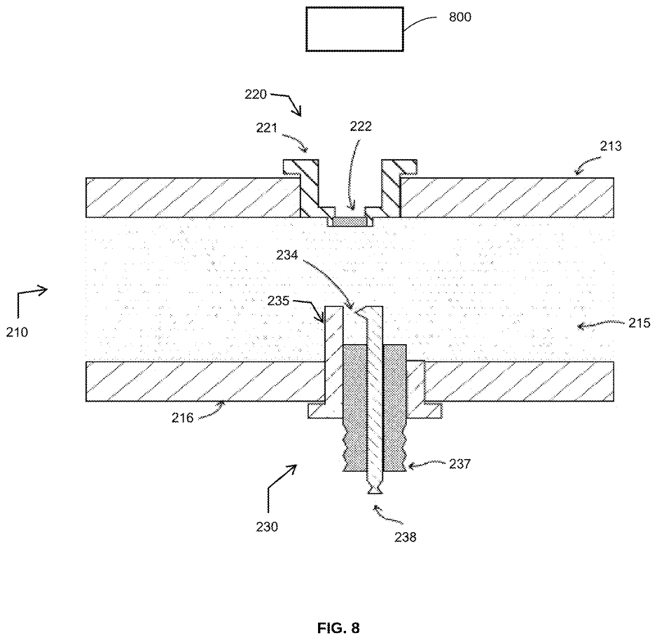

FIG. 8 illustrates a single point X-ray source with an X-ray detector 800 positioned to receive X-rays generated by the spark gap assembly 230. FIG. 8 depicts the same components as FIG. 2, including the gas enclosure 210, the window assembly 220 with frame 221 and X-ray transmissive window material 222, and the spark gap assembly 230 with housing 235, electrical insulator 237, and electrical feedthrough 238, with the addition of the X-ray detector 800. The X-ray detector 800 is positioned opposite the spark gap assembly 230 such that X-rays generated at the interface 234 between the tip of the electrical feedthrough 238 and the housing 235 pass through the X-ray transmissive window material 222 and are received by the X-ray detector 800. The X-ray detector 800 can comprise a scintillator-based detector, a direct conversion detector, a flat panel detector, a charge-coupled device (CCD) detector, or other detector technologies capable of detecting X-ray radiation and converting the detected radiation into electrical signals for image processing. The X-ray detector 800 can include a detection surface configured to receive X-rays over an area corresponding to the X-ray beam emitted through the X-ray transmissive window material 222. The X-ray detector 800 can be mounted to a support structure that positions the detector at a predetermined distance from the window assembly 220 to achieve desired imaging geometry and magnification characteristics. In some implementations, each spark gap assembly of the plurality of spark gap assemblies 130 of the multi-point gas-discharge X-ray source 100 has a corresponding X-ray detector positioned to receive X-rays generated by that spark gap assembly, such that each X-ray source point in the system is paired with its own dedicated X-ray detector. The X-ray detector 800 can be implemented with any of the spark gap assembly and window assembly configurations illustrated in FIGS. 2-6. In some implementations, an array of X-ray detectors is used with the multi-point gas-discharge X-ray source 100, where the array of X-ray detectors is positioned within or around the circular configuration of the X-ray source 100 to receive X-rays from the plurality of spark gap assemblies 130 passing through the plurality of X-ray window assemblies 120. The array of X-ray detectors can be positioned within the plane of the X-ray source 100 or offset from the plane of the X-ray source 100 depending on the imaging geometry requirements of the computed tomography application.

In one example implementation, a stationary computed tomography system for industrial pipe inspection incorporates a multi-point gas-discharge X-ray source configured as a complete ring with an inner diameter of 500 millimeters. The gas enclosure comprises a stainless steel tube with a wall thickness of 3 millimeters and an outer diameter of 25 millimeters, bent into a circular configuration. The system includes thirty-six spark gap assemblies and thirty-six corresponding X-ray window assemblies positioned at 10-degree angular intervals around the circumference of the gas enclosure.

Each X-ray window assembly in this implementation includes a thin-rolled beryllium window with a thickness of 250 micrometers brazed to a threaded titanium frame. The beryllium window provides high X-ray transmission efficiency exceeding 95 percent for photon energies above 10 keV while maintaining structural integrity under the pressure differential between the gas enclosure interior and atmospheric pressure. The titanium frame incorporates a tapered thread design that creates a metal-to-metal seal when installed into the tapped holes on the inner diameter of the gas enclosure.

Each spark gap assembly in this implementation includes a tungsten electrode with a diameter of 2 millimeters inserted into an alumina ceramic tube and brazed using an active metal brazing alloy to form a hermetic electrical feedthrough. The tungsten electrode extends 5 millimeters beyond the ceramic tube to form the high-voltage terminal of the spark gap. The electrical feedthrough is brazed to a stainless steel housing that includes a machined protrusion establishing a spark gap distance of 3 millimeters between the electrode tip and the grounded housing surface. The housing incorporates external threads and an O-ring groove for installation into the outer diameter of the gas enclosure.

The gas enclosure in this implementation is filled with a mixture of 80 percent Argon and 20 percent Nitrogen at a total pressure of 50 torr. This gas mixture provides stable spark discharge characteristics with consistent X-ray output across the operating temperature range of 10 degrees Celsius to 40 degrees Celsius. The low pressure environment reduces the breakdown voltage required to initiate gas discharge, enabling the use of a compact high-voltage power supply rated at 30 kilovolts.

The high-voltage power supply in this implementation connects to all thirty-six spark gap assemblies through individual switching circuits that enable sequential activation with a minimum pulse duration of 100 nanoseconds and a maximum repetition rate of 10 kilohertz per spark gap assembly. The power supply activates each spark gap assembly in sequence around the ring, completing a full rotation through all thirty-six positions in 3.6 milliseconds when operating at maximum speed. This rapid sequential activation enables real-time computed tomography imaging of moving objects such as products on a conveyor belt.

An array of thirty-six X-ray detectors is positioned within the plane of the X-ray source ring, with each detector aligned to receive X-rays from the spark gap assembly located diametrically opposite on the ring. Each X-ray detector comprises a cesium iodide scintillator coupled to a photodiode array with 512 detection elements, providing spatial resolution of 0.5 millimeters across a 256-millimeter detection width. The detectors convert received X-rays into electrical signals that are digitized and transmitted to an image processing computer for tomographic reconstruction.

This implementation achieves several technical advantages over conventional rotating-gantry computed tomography systems. The elimination of rotating components reduces the total system weight from over 500 kilograms typical of rotating systems to approximately 45 kilograms, enabling deployment in mobile inspection vehicles and remote field locations. The absence of mechanical rotation eliminates vibration-induced image artifacts and removes the speed limitations imposed by centrifugal forces on rotating gantries, enabling image acquisition rates exceeding 100 frames per second. The gas-discharge X-ray generation mechanism provides inherent pulse-mode operation without requiring additional beam switching components, simplifying the system architecture and reducing component count. The modular design of the spark gap assemblies and X-ray window assemblies enables field replacement of individual components without disassembling the entire system, reducing maintenance downtime from days to hours. The pinch effect phenomenon in the gas discharge produces X-ray photons with energies significantly higher than the applied voltage, enabling penetration of steel pipe walls up to 15 millimeters thick using a 30-kilovolt power supply that would require 80 kilovolts or more in a conventional vacuum X-ray tube.

The foregoing detailed description includes illustrative examples of various aspects and implementations and provides an overview or framework for understanding the nature and character of the claimed aspects and implementations. The drawings provide illustration and a further understanding of the various aspects and implementations and are incorporated in and constitute a part of this specification. The constituent elements of the disclosed device and system listed herein are intended to be exemplary only, and it is not intended that this list be used to limit the device of the present application to just these elements. Persons having ordinary skill in the art relevant to the present disclosure may understand there to be equivalent elements that may be substituted within the present disclosure without changing the essential function or operation of the device. Terms such as ‘approximate,’ ‘approximately,’ ‘about,’ etc., as used herein indicate a deviation of within +/−10%. Relationships between the various elements of the disclosed device as described herein are presented as illustrative examples only, and not intended to limit the scope or nature of the relationships between the various elements. Persons of ordinary skill in the art may appreciate that numerous design configurations may be possible to enjoy the functional benefits of the inventive systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

While operations are depicted in the drawings in a particular order, such operations are not required to be performed in the particular order shown or in sequential order, and all illustrated operations are not required to be performed. Actions described herein can be performed in a different order. The separation of various system components does not require separation in all implementations, and the described program components can be included in a single hardware or software product.

The phraseology and terminology used herein is for the purpose of description and should not be regarded as limiting. Any references to implementations or elements or acts of the systems and methods herein referred to in the singular may also embrace implementations including a plurality of these elements, and any references in plural to any implementation or element or act herein may also embrace implementations including only a single element. Any implementation disclosed herein may be combined with any other implementation or embodiment.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. An X-ray source, comprising:
a gas enclosure configured to retain a mixture of gasses at a pressure below atmospheric pressure;
a plurality of spark gap assemblies mounted to the gas enclosure, each spark gap assembly of the plurality of spark gap assemblies comprising an electrical feedthrough configured to generate X-rays via gas discharge across a spark gap; and
a plurality of X-ray window assemblies mounted to the gas enclosure, each X-ray window assembly of the plurality of X-ray window assemblies positioned adjacent a corresponding spark gap assembly of the plurality of spark gap assemblies such that X-rays generated by the corresponding spark gap assembly pass through the X-ray window assembly.

2. The X-ray source of claim 1, wherein the gas enclosure is configured to retain the mixture of gasses at a total pressure between 10-3 torr and 400 torr.

3. The X-ray source of claim 1, wherein the mixture of gasses comprises at least one of Hydrogen, Nitrogen, Methane, Argon, or Xenon.

4. The X-ray source of claim 1, wherein each X-ray window assembly of the plurality of X-ray window assemblies comprises an X-ray transmissive window material comprising at least one of rolled beryllium, chemical vapor deposition diamond, a supported polymer film, or a graphene film.

5. The X-ray source of claim 4, wherein each X-ray window assembly of the plurality of X-ray window assemblies further comprises a frame supporting the X-ray transmissive window material.

6. The X-ray source of claim 1, wherein the gas enclosure comprises a tube bent into a circular shape.

7. The X-ray source of claim 6, wherein the plurality of X-ray window assemblies are mounted to an inner surface of the tube and the plurality of spark gap assemblies are mounted to an outer surface of the tube.

8. The X-ray source of claim 7, wherein the plurality of X-ray window assemblies and the plurality of spark gap assemblies are positioned at regular intervals around the tube.

9. The X-ray source of claim 1, wherein each spark gap assembly of the plurality of spark gap assemblies further comprises:
an electrical insulator enshrouding the electrical feedthrough; and
a housing, wherein the spark gap is formed between a tip of the electrical feedthrough and the housing.

10. The X-ray source of claim 1, wherein each spark gap assembly of the plurality of spark gap assemblies is screw mounted to the gas enclosure.

11. The X-ray source of claim 1, further comprising a triggering grid positioned between a tip of the electrical feedthrough and an X-ray transmissive window material of a corresponding X-ray window assembly, wherein the triggering grid is configured to control initiation of the gas discharge.

12. A method for manufacturing a multi-point gas-discharge X-ray source, the method comprising:
forming a gas enclosure by bending a tube into a circular shape;
connecting a plurality of X-ray window assemblies to an inner surface of the gas enclosure;
connecting a plurality of spark gap assemblies to an outer surface of the gas enclosure, each spark gap assembly of the plurality of spark gap assemblies positioned adjacent a corresponding X-ray window assembly of the plurality of X-ray window assemblies; and
filling the gas enclosure with a mixture of gasses at a pressure below atmospheric pressure.

13. The method of claim 12, further comprising drilling and tapping holes at periodic positions around the tube prior to connecting the plurality of X-ray window assemblies and the plurality of spark gap assemblies.

14. The method of claim 12, further comprising forming each X-ray window assembly of the plurality of X-ray window assemblies by bonding an X-ray transmissive window material to a frame.

15. The method of claim 14, wherein bonding the X-ray transmissive window material to the frame comprises at least one of brazing, soldering, or applying an adhesive.

16. The method of claim 12, further comprising connecting a high voltage power supply to the plurality of spark gap assemblies, wherein the high voltage power supply is configured to control a sequence of sparks in each spark gap assembly of the plurality of spark gap assemblies.

17. A stationary computed tomography system, comprising:
a multi-point gas-discharge X-ray source comprising:
a gas enclosure containing a mixture of gasses at a pressure below atmospheric pressure;
a plurality of spark gap assemblies mounted to the gas enclosure, each spark gap assembly comprising an electrical feedthrough; and
a plurality of X-ray window assemblies mounted to the gas enclosure; and
a power supply connected to the plurality of spark gap assemblies and configured to sequentially activate the plurality of spark gap assemblies to generate X-rays.

18. The stationary computed tomography system of claim 17, wherein the gas enclosure comprises a tube bent into a circular shape, and wherein the plurality of X-ray window assemblies are mounted to an inner surface of the tube and the plurality of spark gap assemblies are mounted to an outer surface of the tube.

19. The stationary computed tomography system of claim 18, wherein the plurality of X-ray window assemblies and the plurality of spark gap assemblies are positioned at regular intervals around the tube.

20. The stationary computed tomography system of claim 17, further comprising one or more X-ray detectors positioned to receive X-rays generated by the plurality of spark gap assemblies and passing through the plurality of X-ray window assemblies.
